(19) United States
(12) Patent Application Publication
(10) Pub. No.: US 2005/0246668 A1
(43) Pub. Date: Nov. 3, 2005

(54) Method and device for an equivalence comparison of digital circuits

(76) Inventors: Wolfgang Gunther, Munchen (DE); Rolf Drechlser, Bremen (DE)

Correspondence Address: BRINKS HOFER GILSON & LIONE;INFINEON, PO BOX 10395, CHICAGO, IL, 60610, US

(21) Appl. No.: 10/526,002

(22) PCT Filed: Aug. 28, 2003
(86) PCT No.: PCT/EP03/09548

§ 371 Date: Feb. 25, 2005

(30) Foreign Application Priority Data
Aug. 30, 2002 (DE) 10240133.0

(51) Int. Cl. G06F 17/50

(52) U.S. Cl. 716/3

(57) ABSTRACT

Assignment information items for assigning signal-path identifiers of circuit descriptions in accordance with a second description format also as a function of the circuit description in accordance with a first description format, from which circuit description the circuit descriptions in accordance with the second description format have been produced by conversion. The circuit descriptions in accordance with the second description format are generated from the circuit description in accordance with the first description format in such a way that the information content is not smaller in regard to the signal-path identifiers, with the result that the assignment of the signal-path identifiers in an equivalence comparison is facilitated.

The present invention relates to a method and also to a device for generating assignment information for signal-path identifiers in circuit descriptions for describing digital circuits in accordance with different description formats. Furthermore, the present invention relates to a digital storage medium with control signals for executing the methods according to the invention on a data processing device.

The validation of individual design steps by simulation methods clearly comes up against its limits in the design of digital circuits. Current ASICs may comprise several million gates so that, as a result of the constantly increasing complexity of the designs accompanied simultaneously by desired reduced development times, the scope of the simulation runs performed for ensuring the necessary quality is no longer adequate. Even simulation runs that extend over days and weeks can achieve only a fraction of the coverage. In addition to the running time problem, the conventional simulation also comes up against its limits at other points. Thus, random simulation stimuli (random pattern simulation) does not in general cover all the difficult situations, so-called corner cases. A further problem that arises immediately following the discovery of an error is correction. Here, again, simulation provides little help in regard to the location of the errors in the description. Although the effect becomes visible during the error discovery, the reason for the incorrect behaviour does not directly follow therefrom. In the case of complex designs, the diagnosis of the error location, however, acquires an ever greater importance since it is difficult to survey the entire design.

In contrast to conventional simulation methods, formal verification, i.e. the automatic performance of mathematical proofs in order to compare two digital circuits suggests itself. Equivalence comparison on the basis of formal methods offers, in contrast to simulation, numerous advantages. Thus, equivalence comparison yields a result that can be equated to a complete simulation, i.e. a simulation of all the input values. This exhaustive simulation cannot be achieved by conventional methods for reasons of complexity. In addition thereto, this is achieved with very short running times and low memory location consumption. In past years, a plurality of commercial tools has therefore been developed, such as, for example, the GateCOMP, FormalPro and Formality tools.

These known methods for equivalence comparison use circuit descriptions of digital circuits at a low abstraction level. In the course of the development of a digital circuit, the design first starts at a high abstraction level in order to facilitate the comprehension for the persons involved. In order ultimately to be able to produce the digital circuit to be designed, the circuit description is converted into a lower abstraction-level format in order to have suitable input data for the production process. In this connection, the description of the digital circuit is brought to a lower abstraction level that, although it yields better starting conditions for the production process, it is more difficult to read.

A circuit description in accordance with a description format of a high abstraction level may, for example, correspond to the register-transfer level in which, for example, the behaviour of the circuit and the interrelationship of various signals are also evident. To reduce the abstraction level, such a circuit description can be converted into a network list in which the interconnection of individual gates or functional elements is stored, but in which the comprehension is made more difficult for the persons involved.

In the course of converting a circuit description at a high abstraction level at the beginning of the design to a circuit description at a lower abstraction level, additional modifications are executed on the digital circuit. These may be, for example, optimization for the purpose of testability of the resultant digital circuit or an optimization of the signal-propagations times. In addition, it is often necessary towards the end of the design process also to make changes in the digital circuit that are then performed, however, on the circuit description at the lower abstraction level, as a result of which the correctness of the changes made is more difficult to control due to the low abstraction level.

At the end of the development procedure, a circuit description of the digital circuit is now available at a low abstraction level, changes being made in the course of the development that are to be tested. In this process, the original circuit description at the high abstraction level is converted directly to a low abstraction level without making the modifications in order to obtain a comparison description at a low abstraction level. Said comparison description is subjected to an equivalence comparison with the circuit description obtained at the end of the development procedure in order to test the modifications. The equivalence comparison takes place, in particular, on the basis of signal paths within the digital circuit to which signal-path identifiers are assigned. For a proper equivalence comparison, the precise assignment of the signal-path identifiers is consequently necessary. During the conversion to a lower abstraction level, however, the signal-path identifiers are, as a rule, altered, with the result that, on the basis of the modifications made in the development process, the circuit description generated at the low abstraction level uses signal-path identifiers other than the comparison description. In this case, the appropriate assignments have disadvantageously to be created manually in order to be able to perform the equivalence comparison, which is expensive and, under certain circumstances, is even impossible.

The object of the present invention is therefore to create a system for facilitating the assignment of signal paths in circuit descriptions of a low abstraction level.

The object according to the invention is achieved by a method having the features of claim 1 or 10 or a device having the features of claim 7 or 14 or a digital storage medium having the features of claim 9 or 16. The subclaims each define preferred and advantageous embodiments of the present invention.

According to the invention, to produce the assignments of the signal path identifiers from two different circuit descriptions in accordance with the two description formats, to at least some extent use is also made of information of the circuit description in accordance with the first description format from which the circuit descriptions in accordance with the second description format were generated by conversion. Said information may be used to trace changes in the signal-path identifiers of individual signal paths and to create assignments. In particular, in cases of higher data types, such as, for example, records that comprise a plurality of signal paths, the signal paths can be better assigned. Thus, for example, a circuit description in accordance with the first description format may comprise signal-path group identifiers that denote a group of signal paths. Said group of signal paths may in turn be subdivided into subgroups having their own group identifications. During the conversion of the circuit description to the second description format, it may occur in this connection that the signal paths that were covered by the signal group identifier all contain all the designation of the signal-path group identifier plus an index. On the basis of the index alone, it is not at all evident what subdesignation a certain signal path had or to which subgroup a certain signal path has belonged.

The first description format stores the digital circuit preferably in a circuit description in accordance with the register-transfer level. The second description format may advantageously be the network-list format.

The assignment information generated by the method according to the invention or the device according to the invention may be generated as a separate list that is used by a method or a device to perform the equivalence comparison. The assignment information may likewise already be generated where the equivalence comparison itself is performed. Thus, a device or a method for performing the equivalence comparison may already comprise the generation of the assignment information, with the result that, in this case, the equivalence comparison is performed between two circuit descriptions in accordance with the second description format while simultaneously taking account a circuit description in accordance with the first description format.

In the course of the circuit description of a digital circuit in accordance with the first description format to a circuit description of the digital circuit in accordance with the second description format, numerous circuit descriptions may under certain circumstances be produced that may have different description formats of various abstraction levels. For the performance of the invention, it is unimportant whether, during the generation of the assignment information, a circuit arrangement in accordance with the highest abstraction level occurring is used or a circuit description of a subordinate abstraction level, provided a circuit description in accordance with a description format at an abstraction level is used that is above the abstraction level of the circuit descriptions of the second description format between which ultimately the equivalence comparison is performed.

A plurality of circuit descriptions at higher abstraction levels may likewise also be used.

The present invention may be performed by devices designed only for this purpose or by generally usable, programmable devices. In the latter case, the device may be a personal computer, a data processing system, a workstation or another programmable device, in the latter case the invention also comprising a data medium that has suitably installed control signals that are installed in such a way that they perform the methods according to the invention in conjunction with a data processing system. For this purpose, the data processing system must be controlled by the control signals on the data medium, for which purpose the data processing system preferably has a device for reading out the control signals from the data medium.

The assignment of signal-path identifiers is also designated as matching. In one example, the first circuit description is available in the VHDL format, which stores the digital circuit at the register-transfer level. The second description format corresponds to the GAT format and is a network-list format.

VHDL is converted into the GAT format in the form of intermediate stages in a plurality of phases. First, the VHDL description is read in and represented in internal data structures (parsing). From said representation, the signals are extracted. The corresponding allocations are analysed for each signal and the respective transition functions are calculated. For many signals, storage elements (flipflops) are generated, while the remainder can be simply connected. Then the signals are broken down into individual bits. Correspondingly, names for the individual bits are generated starting from the signal names. Finally, a few reductions also follow at bit level, such as the removal of flipflops that are no longer needed after the transition to the bit level.

In accordance with the solution according to the invention, the procedure is as follows; if various signals represent the same function and are therefore represented by the same flipflops, said flipflop is allocated a list of names (instead of as hitherto a single name). If necessary, the list may be divided into a main name and a plurality of secondary names. During the breakdown of signals into individual bits, secondary names are generated in the same way in addition to the main name. If complicated data types are used, either possible secondary names can be generated or a reference to the position can be inserted in the respective data type. On the whole, the generation of the circuit description in accordance with the second description format while retaining the information content in regard to the signal-path identifiers is not substantially more expensive than the conversion performed in accordance with the prior art since the calculation of the transition functions needs substantially more time and capacity than the generation of the signal names. As a result of the use of additional information from a higher abstraction level, name-based methods may consequently form an approach that can find a result even in difficult cases.

In the abovementioned case, in which that information content of the circuit description in accordance with the first description format that is needed for the improved matching is retained in the conversion into the circuit description in accordance with the second description format, the equivalence comparison can also only be performed as a function of the circuit descriptions in accordance with the second description format since the circuit descriptions in accordance with the second description format comprise adequate information content.

The present invention is also useful in a method or a device for generating a digitally stored circuit description, in which, according to the invention, the generated circuit description in accordance with the second description format is situated at a lower abstraction level than a circuit description in accordance with the first description format from which the circuit description in accordance with the second description format has been generated. This procedure, which is generally also denoted as conversion, results in an alteration of the signal-path identifiers, in which connection, according to the invention, the information content of the signal-path identifiers does not decrease. In this way, the result is achieved that, on the one hand, the abstraction level can be reduced and the circuit description can be better prepared for initiating the production of the digital circuit and, on the other hand, improved output conditions for an equivalence comparison are created. The retention of a high information content in regard to the signal-path identifiers of the conversion of the circuit description substantially simplifies the subsequent equivalence comparison.

To retain the information content in regard to the signal-path identifiers, for example, during the resolution of signal-path group identifiers, signal-path identifiers may be assigned to the signal paths of the group, in which signal-path identifiers both the designation of the signal-path group identification and a subdesignation of the corresponding individual signal paths or the signal-path subgroup appear.

The retention of the original information content in regard to the signal-path identifiers can also be achieved in that changes in the signal-path identifications are documented. Said changes may, for example, be stored at suitable positions in the digitally stored circuit description in accordance with the second description format as changes, with the result that the programs can access the changes made, either to generate assignment information or immediately to perform the equivalence comparison at this point, and may take them into account in the assignment of signal paths.

Regardless thereof, references to interrelated signal paths can be generated and be stored with the circuit description in accordance with the second description format, the interrelated signal paths in the circuit description in accordance with the first description format having been characterized as interrelated and this identification having been lost in the direct signal-path identification during the generation of the circuit description in accordance with the second description format.

The invention is explained in greater detail below on the basis of a preferred exemplary embodiment with reference to the accompanying drawing.

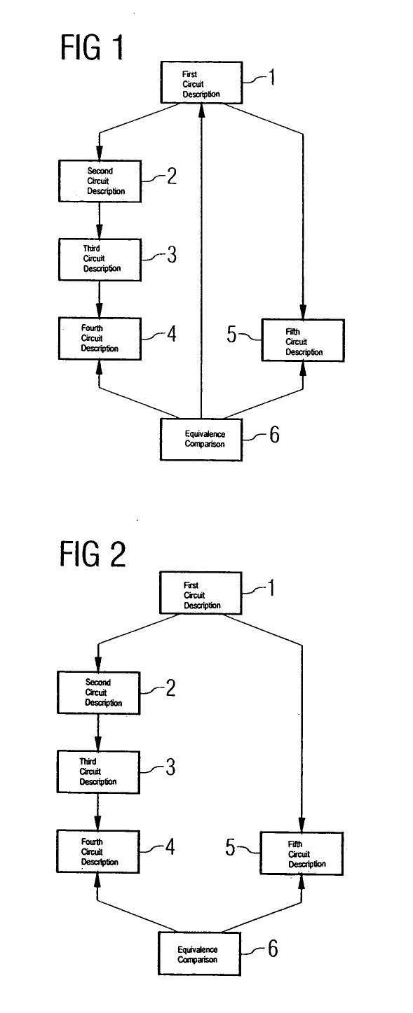

FIG. 1 shows diagrammatically the generation of various circuit descriptions with concluding equivalence comparison in accordance with the exemplary embodiment of the present invention, and

FIG. 2 shows diagrammatically the generation of various circuit descriptions with concluding equivalence comparison in accordance with the prior art.

Prior to the description of the exemplary embodiment of the present invention, the procedure according to the prior art in FIG. 2 is described. Proceeding from a first circuit description 1 in accordance with a first description format, the digital circuit described therein is to be converted into a fourth circuit description that stores the digital circuit in accordance with a second description format. The fourth circuit description 4 has the advantage that it is better suited as a basis for the production of the digital circuit. Disadvantageously, however, in accordance with the second description format, the digital circuit is stored at a lower abstraction level than in accordance with the first description format, with the result that the fourth circuit description 4 is more difficult to understand for the persons involved. In the progression of the development from the first circuit description 1 to the fourth circuit description 4, further intermediate states are traversed in which modifications are made to the circuit, for example, for the purposes of testability, of observability or simply only on the basis of change requirements that have become necessary only at the end. Said intermediate stages are represented by the second circuit description 2 or the third circuit description 3. Although the modifications made up to the fourth circuit description 4 are needed, they should not alter the basic function of the digital circuit stored by the first circuit description 1.

In order to determine whether changes in the function of the digital circuit have occurred between the first circuit description 1 and the fourth circuit description 4 ultimately obtained and which ones, an equivalence comparison is performed. During said equivalence comparison, which is performed by a program shown as block 6, the equivalence is determined or changes are revealed by two circuit descriptions 4, 5 in accordance with the second description format by using mathematical methods or proofs.

For this purpose, a fifth circuit description 5 in accordance with the second description format is generated from the first circuit description 1 in accordance with the first description format, in which connection the modifications made on the path to the generation of the fourth circuit description 4 are not performed. The fourth and the fifth circuit descriptions 4, 5 must accordingly always have the same function given correctly made modifications at the intermediate stages of the second and third circuit descriptions 3, 4. The equivalence comparison 6 therefore compares the equivalence between the fourth circuit description 4 and the fifth circuit description 5. Owing to the different history of origin, however, signal-path identifiers may vary in the fourth circuit description 4 and in the fifth circuit description 5 although they relate to the same signal paths.

FIG. 1 shows the diagrammatic representation of the procedure in accordance with the system according to the invention. As described before in connection with the prior art, a first circuit description 1 of a digital circuit serves as starting point. A fourth circuit description 4 in accordance with the second description format is generated via the intermediate stages of a second circuit description 2 and a third circuit description 3, whereas the first circuit description was in accordance with the first description format. In accordance with the second description format, digital circuits are stored at a lower abstraction level than in accordance with the first description format. The fourth circuit description 4 in accordance with the second description format is, however, better suited to provide the preconditions of the production of the digital circuit. Just like the development process in accordance with the prior art, the modifications in connection with the second circuit description 2 and the third circuit description 3 are not performed to alter the function of the digital circuit basically, but are performed for better testability and/or observability or simply only on the basis of changes planned in the short term.

To perform the equivalence comparison, a fifth circuit description 5 in accordance with the second description format is generated directly from the first circuit description 1, the modifications made on the path to the creation of the fourth circuit description 4 not being made.

The equivalence comparison 6 now accesses both the fourth circuit description 4 and the fifth circuit description 5 as well as the first circuit description 1 in accordance with the first description format. The equivalence comparison 6 evaluates in the first circuit description 1, in particular, the signal-path identification in order to be able to assign the signal-path identifier better in the fourth circuit description 4 and the fifth circuit description 5.

How the assignment information items are generated for the equivalence comparison will be revealed below on the basis of an exemplary signal-path identifier.

Inter alia, the first signal-path description 1 in the example described comprises a record of the following definitions:

| TYPE IO_commonbus_t IS RECORD | | |
|---|---|---|
| IO_adrval | : std_ulogic; | -- Address/Command-Valid |
| IO_dval | : std_ulogic; | -- Data-Valid |
| IO_adbus | : std_ulogic_vector(31 DOWNTO 0); -- Data/Address-Bus | |
| flsg | : std_ulogic; | -- Error-Signal |

END RECORD;

The abovementioned record consequently contains 35 individual signals whose signal-path identifiers are as follows:
ioc_bus_sense-flsg
ioc_bus_sense_io_adbus (0)
ioc_bus_sense_io_adbus (1)
ioc_bus_sense_io_adbus (2)
ioc_bus_sense_io_adbus (3)
ioc_bus_sense_io_adbus (4)
ioc_bus_sense_io_adbus (5)
ioc_bus_sense_io_adbus (6)
ioc_bus_sense_io_adbus (7)
ioc_bus_sense_io_adbus (8)
ioc_bus_sense_io_adbus (9)
ioc_bus_sense_io_adbus (10)
ioc_bus_sense_io_adbus (11)
ioc_bus_sense_io_adbus (12)
ioc_bus_sense_io_adbus (13)
ioc_bus_sense_io_adbus (14)
ioc_bus_sense_io_adbus (15)
ioc_bus_sense_io_adbus (16)
ioc_bus_sense_io_adbus (17)
ioc_bus_sense_io_adbus (18)
ioc_bus_sense_io_adbus (19)
ioc_bus_sense_io_adbus (20)
ioc_bus_sense_io_adbus (21)
ioc_bus_sense_io_adbus (22)
ioc_bus_sense_io_adbus (23)
ioc_bus_sense_io_adbus (24)
ioc_bus_sense_io_adbus (25)
ioc_bus_sense_io_adbus (26)
ioc_bus_sense_io_adbus (27)
ioc_bus_sense_io_adbus (28)
ioc_bus_sense_io_adbus (29)
ioc_bus_sense_io_adbus (30)
ioc_bus_sense_io_adbus (31)
ioc_bus_sense_io_adrval
ioc_bus_sense_io_dval

In the generation of the fourth and/or fifth circuit description 4, 5, the information of the record has been lost, with the result that only the following signal-path identifiers are recovered in said circuit descriptions in accordance with the second description format:
ioc_bus_sense [0]
ioc_bus_sense [1]
ioc_bus_sense [2]
ioc_bus_sense [3]
ioc_bus_sense [4]
ioc_bus_sense [5]
ioc_bus_sense [6]
ioc_bus_sense [7]
ioc_bus_sense [8]
ioc_bus_sense [9]
ioc_bus_sense [10]
ioc_bus_sense [11]
ioc_bus_sense [12]
ioc_bus_sense [13]
ioc_bus_sense [14]
ioc_bus_sense [15]
ioc_bus_sense [16]
ioc_bus_sense [17]
ioc_bus_sense [18]
ioc_bus_sense [19]
ioc_bus_sense [20]
ioc_bus_sense [21]
ioc_bus_sense [22]
ioc_bus_sense [23]
ioc_bus_sense [24]
ioc_bus_sense [25]
ioc_bus_sense [26]
ioc_bus_sense [27]
ioc_bus_sense [28]
ioc_bus_sense [29]
ioc_bus_sense [30]
ioc_bus_sense [31]
ioc_bus_sense [32]
ioc_bus_sense [33]
ioc_bus_sense [34]

Again, 35 signals are involved whose signal-path identifiers differ only in the index and no assignment is possible.

However, taking the record into account, it is evident that a 32-bit bus and 3 control signals must be involved.

With the aid of said information items and, optionally, of the sequence of appearance of the individual signal-path identifiers and, optionally, of information about the way in which signal-path identifiers are altered in the conversion from the first description format to the second description format, the signal-path identifiers of the fourth circuit description 4 and of the fifth circuit description 5 can be assigned to one another in the equivalence comparison 6.

Consequently, with the aid of the system according to the invention, the matching and, consequently, the performance of the equivalence comparison is substantially simplified.

1. A method for generating assignment information for assigning signal-path identifiers of signal paths of at least two different digitally stored circuit descriptions in accordance with a first description format for describing digital circuits, wherein the at least two circuit descriptions are each generated by converting a circuit description in accordance with a second description format, and the circuit description in accordance with the second description format has a higher information content in regard to the signal-path identifiers than the circuit descriptions in accordance with the first description format, and wherein the assignment information is generated as a function of the at least two circuit descriptions in accordance with the first description format and as a function of at least a part of the circuit description in accordance with the second description format.

2. The method according to claim 1, wherein the second description format is a description at a register-transfer level.

3. The method according to claim 1, wherein the first description format is a network-list format.

4. The method according to claim 1, wherein the assignment information is generated as a function of signal-path identifiers that identify a plurality of interrelated signal paths.

5. The method according to claim 1, wherein the first description format stores digital circuits at a lower abstraction level than the second description format.

6. The method according to claim 1, wherein the assignment information is digitally stored.

7. A device for generating assignment information for assigning signal-path identifiers of signal paths of at least two digitally stored circuit descriptions in accordance with a first description format for describing digital circuits, wherein the at least two circuit descriptions are each generated by converting a circuit description in accordance with a second description format, and the circuit description in accordance with the second description format comprises a higher information content in regard to the signal-path identifiers than the circuit descriptions in accordance with the first description format, wherein the device has means for reading the digitally stored circuit descriptions in accordance with the first description format and for reading the circuit description in accordance with the second description format and data processing means, and wherein the data processing means are designed in such a way that they generate the assignment information as a function of the at least two circuit descriptions in accordance with the first description format and at least a part of the circuit description in accordance with the second description format.

8. The device according to claim 7, where the device is designed to perform a method wherein at least one of:
the first description format is a network-list format:
the assignment information is generated as a function of signal-path identifiers that identify a plurality of interrelated signal paths;
the first description format stores digital circuits at a lower abstraction level than the second description format; and
the assignment information is digitally stored.

9. A digital storage medium having electronically readable control signals that are designed in such a way that they can interact with a programmable data processing device in such a way that the data processing device executes a method according to claim 1.

10. A computer-program product comprising a program code, stored on a machine-readable medium, for performing a method according to claim 1 if the program runs on a computer or is used in the computer.

11. A method for generating a digitally stored circuit description in accordance with a first description format of a digital circuit from a circuit description in accordance with a second description format of the digital circuit, wherein the circuit description in accordance with the first description format stores the digital circuit at a lower abstraction level than the circuit description in accordance with the second description format, and the circuit descriptions in accordance with the two description formats each comprise signal-path identifiers of signal paths of the digital circuit, and wherein the circuit description in accordance with the first description format is generated in such a way that the circuit description in accordance with the first description format has just as high an information content in regard to the signal-path identifiers as the circuit description in accordance with the second description format.

12. The method according to claim 11, wherein the circuit description in accordance with the first description format is generated in such a way that the circuit description in accordance with the first description format contains information about changes in the signal-path identifiers of the circuit description in accordance with the second description format as compared to the signal-path identifiers of the generated circuit description in accordance with the first description format.

13. The method according to claim 11 or 12, wherein the circuit description in accordance with the first description format is generated in such a way that the circuit description in accordance with the first description format comprises signal-path group identifiers that indicate which signal paths in the circuit description in accordance with the second description format are provided with signal-path identifiers forming a group.

14. The method according to claim 13, wherein the signal-path group identifiers in the circuit description in accordance with the first description format are a reference to the signal-path identifiers in the circuit description in accordance with the first description format whose assigned signal paths in the circuit description in accordance with the second description format have as a group a common signal-path identifier.

15. A device for generating a digitally stored circuit description of a digital circuit in accordance with a first description format from a circuit description in accordance with a first description format of the digital circuit, wherein the circuit description in accordance with the second description format stores the digital circuit in a lower abstraction level than the circuit description in accordance with the first description format, and the circuit descriptions in accordance with the two description formats each comprise signal-path identifiers of signal paths of the digital circuit, wherein the device has means for reading the digitally stored circuit description in accordance with the first description format, means for writing the circuit description in accordance with the second description format and data processing means, and wherein the data processing means are designed in such a way that the data processing means generate the circuit description in accordance with the second description format that has just as high an information content in regard to the signal-path identifiers as the circuit description in accordance with the first description format.

16. The device according to claim 15, wherein the device is designed to perform a method in which at least one of:
the circuit description in accordance with the second description format is generated in such a way that the circuit description in accordance with the second description format contains information about chances in the signal-path identifiers of the circuit description in accordance with the first description format as compared to the signal-path identifiers of the generated circuit description in accordance with the second description format:
the circuit description in accordance with the second description format is generated in such a way that the circuit description in accordance with the second description format comprises signal-path group identifiers that indicate which signal paths in the circuit description in accordance with the first description format are provided with signal-path identifiers forming a group, and
the signal-path group identifiers in the circuit description in accordance with the second description format are a reference to the signal-path identifiers in the circuit description in accordance with the second description format whose assigned signal paths in the circuit description in accordance with the first description format have as a group a common signal-path identifier.

17. A digital storage medium comprising electronically readable control signals that are designed in such a way that the control signals can interact with a programmable data processing device in such a way that the data processing device executes a method according to any one of claim 11.

18. A computer-program product comprising a program code, stored on a machine-readable medium, for performing a method according to claim 11 if the program runs on a computer or is used in the computer.
